(19) United States
(12) Patent Application Publication
(10) Pub. No.: US 2026/0113801 A1
(43) Pub. Date: Apr. 23, 2026

(54) METHOD AND DEVICE FOR MULTICAST DATA RECEPTION

(71) Applicant: SHARP KABUSHIKI KAISHA, Sakai City, Osaka (JP)

(72) Inventors: HUNG-CHEN CHEN, Taipei (TW); TZU-WEN CHANG, Taipei (TW); HAI-HAN WANG, Taipei (TW)

(21) Appl. No.: 19/117,256

(22) PCT Filed: Sep. 28, 2023
(86) PCT No.: PCT/CN2023/122763

§ 371 Date: Mar. 31, 2025

Related U.S. Application Data
(60) Provisional application No. 63/412,101, filed on Sep. 30, 2022.

(51) Int. Cl. H04W 76/27

(52) U.S. Cl. CPC H04W 76/27

(57) ABSTRACT

Methods and devices for multicast data reception are provided. A method perform by a user equipment (UE) includes receiving, from a base station (BS), a radio resource control (RRC) release message including a suspend configuration, the suspend configuration allowed to be received by the UE in an RRC inactive state; receiving first data of a first multicast session of the at least one multicast session in the RRC inactive state based on a first configuration that is associated with the first multicast session and that is included in the RRC release message; determining whether a reception quality of the first data of the first multicast session is lower than a first threshold; and triggering an RRC connection resume procedure in case that the reception quality of the first data of the first multicast session is lower than the first threshold.

### CROSS-REFERENCE TO RELATED APPLICATION(S)

The present disclosure claims the benefit of and priority to U.S. Provisional Patent Application Ser. No. 63/412,101, filed on Sep. 30, 2022, entitled “MECHANISM FOR MULTICAST SERVICE DATA RECEPTION IN RRC_INACTIVE STATE,” the content of which is hereby incorporated herein fully by reference into the present disclosure for all purposes.

### FIELD

The present disclosure generally relates to wireless communications and, more particularly, to methods and devices for multicast data reception.

### BACKGROUND

With the tremendous growth in the number of connected devices and the rapid increase in user/network (NW) traffic volume, various efforts have been made to improve different aspects of wireless communication for next-generation wireless communication systems, such as fifth-generation (5G) New Radio (NR), by improving data rate, latency, reliability, and mobility.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation wireless communication systems.

### SUMMARY

The present disclosure is directed to methods and devices for multicast data reception.

According to a first aspect of the present disclosure, a method performed by a User Equipment (UE) for receiving multicast data is provided. The method includes receiving, from a base station (BS), a radio resource control (RRC) release message including a suspend configuration, the suspend configuration indicating at least one multicast session of which data is allowed to be received by the UE in an RRC inactive state; receiving first data of a first multicast session of the at least one multicast session in the RRC inactive state based on a first configuration that is associated with the first multicast session and that is included in the RRC release message; determining whether a reception quality of the first data of the first multicast session is lower than a first threshold; and triggering an RRC connection resume procedure in case that the reception quality of the first data of the first multicast session is lower than the first threshold.

In some implementations of the first aspect of the present disclosure, the first threshold is included in the RRC release message.

In some implementations of the first aspect of the present disclosure, the method further includes stopping receiving the first data of the first multicast session in case that the reception quality of the first data of the first multicast session is lower than the first threshold.

In some implementations of the first aspect of the present disclosure, the first threshold includes at least one of reference signal received power (RSRP) threshold or a reference signal received quality (RSRQ) threshold.

In some implementations of the first aspect of the present disclosure, the method further includes configuring the first threshold for the first multicast session; and configuring a second threshold for a second multicast session of the at least one multicast session.

In some implementations of the first aspect of the present disclosure, the method further includes triggering the RRC connection resume procedure in case that the UE has no valid configurations for receiving the first data of the first multicast session.

In some implementations of the first aspect of the present disclosure, the method further includes receiving, via broadcasting system information, a second configuration of a neighboring cell for receiving the first data of the first multicast session, where the second configuration is associated with the first multicast session; performing a cell reselection procedure to join a re-selected cell; and triggering the RRC connection resume procedure in case that the second configuration associated with the first multicast session is not available for the first multicast session in the re-selected cell.

According to a second aspect of the present disclosure, a UE is provided. The UE includes one or more processors and at least one memory coupled to at least one of the one or more processors. The at least one memory stores a computer-executable program that, when executed by the at least one of the one or more processors, cause the UE to receive, from a BS, an RRC release message including a suspend configuration, the suspend configuration indicating at least one multicast session of which data is allowed to be received by the UE in an RRC inactive state; receive first data of a first multicast session of the at least one multicast session in the RRC inactive state based on a first configuration that is associated with the first multicast session and that is included in the RRC release message; determine whether a reception quality of the first data of the first multicast session is lower than a first threshold; and trigger an RRC connection resume procedure in case that the reception quality of the first data of the first multicast session is lower than the first threshold.

In some implementations of the second aspect of the present disclosure, the first threshold is included in the RRC release message.

In some implementations of the second aspect of the present disclosure, the computer-executable program that, when executed by the at least one of the one or more processors, further causes the UE to: stop receiving the first data of the first multicast session in case that the reception quality of the first data of the first multicast session is lower than the first threshold.

In some implementations of the second aspect of the present disclosure, the first threshold includes at least one of an RSRP threshold or an RSRQ threshold.

In some implementations of the second aspect of the present disclosure, the computer-executable program that, when executed by the at least one of the one or more processors, further causes the UE to: configure the first threshold for the first multicast session; and configure a second threshold for a second multicast session of the at least one multicast session.

In some implementations of the second aspect of the present disclosure, the computer-executable program that, when executed by the at least one of the one or more processors, further causes the UE to: trigger the RRC connection resume procedure in case that the UE has no valid configurations for receiving the first data of the first multicast session.

In some implementations of the second aspect of the present disclosure, the computer-executable program that, when executed by the at least one of the one or more processors, further causes the UE to: receive, via broadcasting system information, a second configuration of a neighboring cell for receiving the first data of the first multicast session, where the second configuration is associated with the first multicast session; perform a cell reselection procedure to join a re-selected cell; and trigger the RRC connection resume procedure in case that the second configuration associated with the first multicast session is not available for the first multicast session in the re-selected cell.

According to a third aspect of the present disclosure, a BS is provided. The BS includes one or more processors and at least one memory coupled to at least one of the one or more processors. The at least one memory stores a computer-executable program that, when executed by the at least one of the one or more processor, cause the BS to transmit, to a UE, an RRC release message including a suspend configuration, the suspend configuration indicating at least one multicast session of which data is allowed to be received by the UE in an RRC inactive state. The RRC release message further includes at least one configuration associated with the at least one multicast session and causes the UE to: receive first data of a first multicast session of the at least one multicast session in the RRC inactive state based on a first configuration associated with the first multicast session, where the first configuration is included in the RRC release message; determine whether a reception quality of the first data of the first multicast session is lower than a first threshold; and trigger an RRC connection resume procedure in case that the reception quality of the first data of the first multicast session is lower than the first threshold.

In some implementations of the third aspect of the present disclosure, the first threshold is included in the RRC release message.

In some implementations of the third aspect of the present disclosure, the RRC release message further causes the UE to: stop receiving the first data of the first multicast session in case that the reception quality of the first data of the first multicast session is lower than the first threshold.

In some implementations of the third aspect of the present disclosure, the first threshold includes at least one of an RSRP threshold or an RSRQ threshold.

In some implementations of the third aspect of the present disclosure, the RRC release message further causes the UE to: configure the first threshold for the first multicast session; and configure a second threshold for a second multicast session of the at least one multicast session.

In some implementations of the third aspect of the present disclosure, the RRC release message further causes the UE to: trigger the RRC connection resume procedure in case that the UE has no valid configurations for receiving the first data of the first multicast session.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a flowchart illustrating a method for multicast data reception, according to an example implementation of the present disclosure.

FIG. 2 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “In some implementations,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any NW function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on computer readable medium such as a memory or other types of storage devices. For example, one or more microprocessors or general-purpose computers with communication processing capability may be programmed with corresponding executable instructions and carry out the described NW function(s) or algorithm(s). The microprocessors or general-purpose computers may be formed of Application-Specific Integrated Circuitries (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional NW elements that provide connection toward the NW. The UE communicates with the NW (e.g., a Core Network (CN), an Evolved Packet Core (EPC) NW, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access NW.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access NW. The BS supports the operations of the cells. Each cell is operable to provide services to at least one UE within its radio coverage. For example, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a DL transmission data, a guard period, and an UL transmission data should at least be included, where the respective portions of the DL transmission data, the guard period, and the UL transmission data should also be configurable, for example, based on the NW dynamics of NR. In addition, SL resources may also be provided in an NR frame to support ProSe services or V2X services.

In addition, the terms “system” and “NW” herein may be used interchangeably. The term “and/or” herein is only an association relationship for describing associated objects, and represents that three relationships may exist. For example, A and/or B may indicate that A exists alone, A and B exist at the same time, or B exists alone. In addition, the character “/” herein generally represents that the former and latter associated objects are in an “or” relationship. Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

Some of the terms, definitions, and abbreviations as given in this document are either imported from existing documentation (European Telecommunications Standards Institute (ETSI), International Telecommunication Union (ITU), or elsewhere) or newly created by 3GPP experts whenever the need for precise vocabulary is identified.

In order to enhance the efficiency of resource delivery, the 3GPP has introduced mechanisms for supporting NR broadcast and multicast services in Release 17 (e.g., TS 38.300 v17.0.0).

A broadcast service is considered as a communication service with lower quality of service (QOS). For a broadcast service, identical content data is provided simultaneously to all UEs within a specific geographical area through a broadcast session, and a UE may receive data of the broadcast service in an RRC idle (e.g., RRC_IDLE), an RRC inactive (e.g., RRC_INACTIVE) or an RRC connected (e.g., RRC_CONNECTED) state.

On the other hand, a multicast service is considered as a communication service with higher QoS. For a multicast service, identical content data are provided simultaneously to a dedicated set of UEs (e.g., UEs that are authorized to receive the multicast data) through a multicast session, and a UE within the dedicated set of UEs may only receive data of the multicast service in the RRC connected state. In addition, the network (NW) or a serving base station may transmit one or more different multicast Multicast and Broadcast Services (MBS) Radio Bearer (MRB) configurations in a dedicated RRC signaling to configure a UE to receive data of a multicast service via a Point to Point (PTP) delivery mode or a Point to Multipoint (PTM) delivery mode. Here, a multicast MRB is a radio bearer configured for multicast delivery/service/session.

The one or more multicast MRB configurations may include configuration(s) of at least one of the following:

multicast MRB with DL only Radio Link Control—Unacknowledged Mode (RLC-UM) entity or with bidirectional RLC-UM entity for PTP transmission;

multicast MRB with Radio Link Control—Acknowledged Mode (RLC-AM) entity for PTP transmission;

multicast MRB with DL only RLC-UM entity for PTM transmission;

multicast MRB with two RLC-UM entities (e.g., including a DL only RLC-UM entity for PTP transmission and a DL only RLC-UM entity for PTM transmission);

multicast MRB with three RLC-UM entities (e.g., including a DL RLC-UM entity for PTP transmission, a UL RLC-UM entity for PTP transmission, and a DL only RLC-UM entity for PTM transmission);

multicast MRB with two RLC entities (e.g., including an RLC-AM entity for PTP transmission and a DL only RLC-UM entity for PTM transmission).

To guarantee higher QoS, Hybrid Automatic Repeat reQuest (HARQ) feedback/retransmission may be applied to both PTP and PTM transmission.

However, restricting UE(s) to receive data of a multicast service/session only in the RRC connected state may not be beneficial for NW capacity, latency reduction and power saving purpose. For example, for a cell with a large number of UEs, if there is an ongoing multicast service which is a Mission Critical Service, the NW may not be able to serve all the UEs at the same time since all the UEs needs to be in the RRC connected state. In addition, UE(s) may need to perform connection establishment procedure to transition into the RRC connected state, leading to increased signaling overhead and intensified competition for random access (RA). Consequently, some UE(s) may experience RA failure temporarily, resulting in unfulfilled requirement(s) for receiving data of such Mission Critical Service. Moreover, keeping in the RRC connected state consumes more power compared to staying in the RRC inactive state or in the RRC idle state.

If receiving data of a multicast service/session in the RRC inactive state is allowed, issues related to mobility (e.g., cell (re)selection) may need to be further considered to guarantee service continuity and reduce unnecessary the RRC resume procedure. Considered issues may be, for example, for receiving/updating related MBS configuration(s) when a UE moving to another camped cell and lacks valid MBS configuration(s) for multicast service data reception in the RRC inactive state. That is, new mechanisms to support multicast service data reception in the RRC inactive state are required for the sake of power saving purpose and service continuity.

Several implementations are described below introducing methods of supporting multicast service data reception in the RRC inactive state, including MBS configuration delivery/update, signaling design, and the corresponding UE behavior after cell (re)selection.

### Mechanisms of Supporting MBS Multicast Reception in RRC_INACTIVE State

In some implementations, a UE may receive (e.g., in the RRC inactive state or the RRC connected state) an RRC release message with suspend configuration indicating at least one of: at least one MBS multicast service/session of which data is allowed to be received in the RRC inactive state, or the associated configuration(s) to be applied when receiving data of multicast service/session in the RRC inactive state.

In some implementations, a UE may receive (e.g., in the RRC inactive state or the RRC connected state) an RRC release message with suspend configuration indicating at least one of: at least one MBS multicast service/session of which data is allowed to be received in the RRC inactive state, or the associated configuration(s) to be applied when the UE camps on the cell from which the UE receives the RRC release message with suspend configuration. When the UE in the RRC inactive state intends to receive data of an MBS multicast service/session, the UE may apply the associated configuration(s) for receiving data of the MBS multicast service/session.

In some implementations, a UE may receive (e.g., in the RRC inactive state or the RRC connected state) an RRC release message with suspend configuration indicating at least one of: data of current (interested) activated MBS multicast service(s)/session(s) is allowed to be received in the RRC inactive state, or the associated configuration(s) to be applied when receiving data of MBS multicast service/session in the RRC inactive state.

In some implementations, a UE may receive (e.g., in the RRC inactive state or the RRC connected state) an RRC release message with suspend configuration indicating at least one of: data of current (interested) activated MBS multicast service(s)/session(s) is allowed to be received in the RRC inactive state, or the associated configuration(s) to be applied when the UE camps on the cell from which the UE receives the RRC release message with suspend configuration. When the UE in the RRC inactive state intends to receive data of an MBS multicast service/session, the UE may apply the associated configuration(s) for receiving data of the MBS multicast service/session.

In some implementations, a UE may transition from the RRC connected state to the RRC inactive state after receiving an RRC release message with suspend configuration.

In some implementations, a UE may receive configuration(s) (e.g., including at least one of BWP configuration, PDCCH configuration, PDSCH configuration, MCCH configuration, or MTCH configuration) for receiving data of an MBS multicast service/session in the RRC inactive state via dedicated signaling or broadcasting system information (e.g., in an MBS-related system information block (SIB)).

In some implementations, part of the configuration(s) for receiving data of an MBS multicast service/session in the RRC inactive state may be provided via dedicated signaling and part of the configuration(s) for receiving data of an MBS multicast service/session in the RRC inactive state may be provided via broadcasting system information.

In some implementations, in a case that certain part of the configuration(s) for receiving data of an MBS multicast service/session in the RRC inactive state is absent (or not present) in the dedicated signaling, the UE may acquire the related information via broadcasting system information.

In some implementations, in a case that a UE cannot receive the complete configuration(s) for receiving data of an MBS multicast service/session in the RRC inactive state from dedicated signaling and broadcasting system information, the UE may stop receiving data of the MBS multicast service/session in the RRC inactive state and may release the stored information related to the configuration(s). The configuration(s) for receiving data of an MBS multicast service/session in the RRC inactive state may be, for example, configuration(s) valid for the current camped cell only, or valid for a configured area (e.g., a list of cells or the area defined by RAN notification area). The definition of a RAN notification area may, for example, follow the definition(s) introduced in TS 38.331 V17.1.0.

In some implementations, a cell or its associated base station may provide at least one of: configuration(s) for receiving data of an MBS multicast service/session in the RRC inactive state within its coverage, or configuration(s) for receiving data of a multicast service/session in the RRC inactive state in neighboring cell(s). For example, a UE may receive a first configuration of a first cell for receiving data of a first multicast service/session when the UE is camping on the first cell and may also receive a second configuration of a second (e.g., neighboring) cell for receiving data of the first multicast service/session when the UE is camping on the second cell. The second configuration may be provided via dedicated signaling (e.g., the RRC release message from the first cell) or via broadcasting system information (e.g., SIB broadcast by the first cell or SIB broadcast by the second cell.)

In some implementations, a UE may receive at least one of: configuration(s) applicable for receiving data of an MBS multicast service/session within current serving cell, or configuration(s) appliable for receiving data of a multicast service/session within neighboring cell(s) via dedicated signaling (e.g., the RRC release message with suspend configuration). In some implementations, a UE may receive at least one of: configuration(s) applicable for or receiving data of a multicast service/session within current serving cell, or configuration(s) appliable or receiving data of a multicast service/session within neighboring cell(s) via broadcasting system information (e.g., an MBS-related SIB broadcast by current serving cell).

### MBS Multicast Reception in RRC_INACTIVE State Within an Area

In some implementations, a UE may receive configuration(s) applicable for receiving data of an MBS multicast service/session within an area (e.g., a list of cells or an area defined by RAN notification area). In some implementations, a serving cell or its associated base station may provide an MBS validity area associated with a multicast service/session (or associated Temporary Mobile Group Identity (TMGI)). In some implementations, a serving cell or its associated base station may provide an MBS validity area associated with configuration(s) used for receiving data of a multicast service/session (or associated TMGI).

For example, a UE may receive a configuration for receiving data of an MBS multicast service/session with an associated MBS validity area from a first cell, where the associated MBS validity area includes the first cell, a second cell, and a third cell. In case that the UE selects to camp on the second cell afterwards, the UE may consider the received configuration is valid for receiving data of the MBS multicast service/session unless the received configuration becomes invalid based on the network's instructions (e.g., paging message), notification (e.g., SIB update notification), or pre-configuration (e.g., based on a timer).

In some implementations, an MBS validity area associated with an MBS multicast service/session may be a list of frequencies. That is, a UE may receive data of an MBS multicast service/session based on received configuration(s) when camped on a cell operates on a frequency including in the list of frequencies.

For example, assume that a first frequency and a second frequency are in the list of frequencies associated with a first MBS. When the UE camps on a first cell that operates on the first frequency, the UE may receive data of the first MBS based on the received configuration(s). When the UE camps on a second cell that operates on a third frequency which is not included in the list of frequencies, the UE may stop receiving data of the first MBS based on the received configuration(s). In this case, the UE may consider the received configuration(s) as invalid. Consequently, the UE may re-acquire MBS-related SIB to update the configuration(s) or initiate an RRC resume procedure to receive new configuration(s).

In some cases, the UE may first check if MBS-related SIB (or the required configuration(s)) is present. If the MBS-related SIB (or the required configuration(s)) is present, the UE may acquire the MBS-related SIB ((or the required configuration(s)) to update the configuration(s). After updating the configuration(s) from SIB, the UE may start receiving data of the first MBS based on the updated configuration(s). If the MBS-related SIB (or the required configuration(s)) is not present, the UE may initiate an RRC resume procedure to request for new configuration(s). After receiving the configuration(s) from dedicated signaling, the UE may start receiving data of the first MBS based on the updated configuration(s), for example, in either the RRC connected state or the RRC inactive state.

In some implementations, when performing cell (re)selection, a frequency belongs to a list of frequencies of an MBS validity associated with an MBS multicast service/session may be considered as the frequency with higher priority (e.g., if the UE intends to receive data of the MBS multicast service/session in the RRC inactive state). For example, assume that a first frequency and a second frequency are in the list of frequencies associated with the first MBS. When performing cell (re)selection, the first and second frequencies may be considered as the higher priority frequencies. That is, the UE may consider cells operations on the first frequency and the second frequency with higher ranking to camp on.

In some implementations, an MBS validity area associated with an MBS multicast service/session may be a list of cell IDs (e.g., Physical Cell Id). That is, a UE may receive data of an MBS multicast service/session based on received configuration(s) when camped on a cell with a cell ID included in the list of cell IDs.

For example, assume that a first cell ID and a second cell ID are in the list of cell IDs associated with a first MBS. When the UE camps on a cell with the first cell ID, the UE may receive data of the first MBS based on the received configuration(s). When the UE camps on a cell with a third cell ID which is not included in the list of cell IDs, the UE may stop receiving data of the first MBS based on the received configuration(s). In this case, the UE may consider the received configuration(s) as invalid. Consequently, the UE may re-acquire MBS-related SIB to update the configuration(s) or initiate an RRC resume procedure to receive new configuration(s).

In some cases, the UE may first check if MBS-related SIB (or the required configuration(s)) is present. If the MBS-related SIB (or the required configuration(s)) is present, the UE may acquire MBS-related SIB ((or the required configuration(s)) to update the configuration(s). After updating the configuration(s) from SIB, the UE may start receiving data of the first MBS based on the updated configuration(s). If MBS-related SIB (or the required configuration(s)) is not present, the UE may initiate an RRC resume procedure to request for new configuration(s). After receiving the configuration(s) from dedicated signaling, the UE may start receiving data of the first MBS based on the updated configuration(s), for example, in either the RRC connected state or the RRC inactive state.

In some implementations, an MBS validity area associated with an MBS multicast service/session may be a list of frequencies and each entry of the list of frequencies may be associated with a list of cell IDs. That is, a UE may receive data of a multicast service/session based on received configuration(s) when camping on a cell operates on a frequency included in the list of frequencies and the cell ID of this cell is included in the corresponding list of cell IDs.

For example, assume that a first frequency and a second frequency are in the list of frequencies associated with a first MBS. In addition, the first frequency is associated with a first cell ID list {#ID1, #ID2} and the second frequency is associated with a second cell ID list {#ID4, #ID5}. When the UE camps on a cell with cell ID #ID1 operating on the first frequency, the UE may receive data of the first MBS based on the received configuration(s). When the UE camps on a cell with cell ID #ID3 operating on the first frequency, the UE may stop receiving data of the first MBS based on the received configuration(s). In this case, the UE may consider the received configuration(s) as invalid. Consequently, the UE may re-acquire MBS-related SIB to update the configuration(s) or initiate an RRC resume procedure to receive new configuration(s).

In some cases, the UE may first check if MBS-related SIB (or the required configuration(s)) is present. If the MBS-related SIB (or the required configuration(s)) is present, the UE may acquire MBS-related SIB ((or the required configuration(s)) to update the configuration(s). After updating the configuration(s) from SIB, the UE may start receiving data of the first MBS based on the updated configuration(s). If the MBS-related SIB (or the required configuration(s)) is not present, the UE may initiate an RRC resume procedure to request for new configuration(s). After receiving the configuration(s) from dedicated signaling, the UE may start receiving data of first MBS based on the updated configuration(s), for example, in either the RRC connected state or the RRC inactive state.

MBS Multicast Reception in RRC_INACTIVE State After/Upon Cell (re)selection

In some implementations, a cell or its associated base station may broadcast an indication indicating whether an MBS multicast service/session is allowed to be received in the RRC inactive state.

For example, a UE may receive configuration(s) from a previous camped cell to receive data of an MBS multicast service/session. After cell (re)selection, the UE may camp on a new cell and may check an indication which is received from the new cell and is associated with the MBS multicast service/session. If the indication is set to a specific first value (e.g., true or 1), the UE may determine that data of the MBS multicast service/session is allowed to be received in the RRC inactive state when camping on this new cell. If the indication is set to a specific second value (e.g., false or 0), the UE may determine that data of the MBS multicast service/session is not allowed to be received in the RRC inactive state when camping on this new cell.

In a case that the indication indicates that data of the MBS multicast service/session is allowed to be received in the RRC inactive state when camping on this cell and the UE has valid configuration(s) to receive data of the MBS multicast service/session in RRC_INACITVE in this cell, the UE may keep receiving data of the MBS multicast service/session in the RRC inactive state.

In a case that the indication indicates that data of the MBS multicast service/session is allowed to be received in the RRC inactive state when camping on this cell but the UE has no valid configuration(s) to receive data of the MBS multicast service/session in RRC_INACITVE in this cell, the UE may stop receiving data of the MBS multicast service/session and may start/initiate a procedure (e.g., re-acquiring MBS-related SIB or initiating an RRC resume procedure) to require valid configuration(s).

In a case that the indication indicates that data of the MBS multicast service/session is not allowed to be received in the RRC inactive state when camping on this cell, the UE may initiate an RRC resume procedure to request for new configuration(s). After receiving the configuration(s) from dedicated signaling, the UE may start receiving data of the (interested) MBS Multicast service/session based on the updated configuration(s), for example, in either the RRC connected state or the RRC inactive state.

In some cases, the RRC resume procedure initiated by the UE may fail (e.g., a timer T300 expires). In this case, the UE may transition back to the RRC idle state and lower layer of the UE (e.g., RRC layer) may inform upper layer of the UE (e.g., NAS layer) with release cause ‘RRC Resume failure.’ Alternatively, the UE may transition back to the RRC idle state and lower layer of the UE (e.g., RRC layer) may inform upper layer of the UE (e.g., NAS layer) with release cause to indicate MBS multicast reception failure.

In some implementations with no explicit indication from the new cell, an MBS multicast service/session may be allowed to be received in the RRC inactive state if the UE has valid configuration(s) to receive data of the MBS multicast service/session in RRC_INACITVE in this cell. If the UE does not have valid configuration(s) to receive data of the MBS multicast service/session in RRC_INACITVE in this cell, the UE may not be allowed to receive data of the MBS multicast service/session in RRC_INACITVE in this cell. Whether the UE has the valid configuration(s) to receive data of the MBS multicast service/session in RRC_INACITVE in this cell may be determined by UE implementations, NW configuration, or NW policy, but not limited thereto. For example, the received configuration may become invalid based on the network's instructions (e.g., paging message), notification (e.g., SIB update notification), or pre-configuration (e.g., based on a timer).

In some implementations, a cell or its associated base station may broadcast an indication indicating whether an MBS multicast service/session is activated or supported by the cell.

For example, a UE may receive configuration(s) from a previous camped cell to receive data of an MBS multicast service/session. After cell (re)selection, the UE may camp on a new cell and may check an indication which is received from the new cell and is associated with the MBS multicast service/session. If the indication is set to a specific first value (e.g., true or 1), the UE may determine that the MBS multicast service/session is activated. If the indication is set to a specific second value (e.g., false or 0), the UE may determine that the MBS multicast service/session is deactivated.

In a case that the indication indicates that data of the MBS multicast service/session is activated, and the UE has valid configuration(s) to receive data of the MBS multicast service/session in RRC_INACITVE in this cell, the UE may keep receiving data of the MBS multicast service/session in the RRC inactive state.

In a case that the indication indicates that the MBS multicast service/session is activated but the UE has no valid configuration(s) to receive data of the MBS multicast service/session in RRC_INACITVE in this cell, the UE may stop receiving data of the MBS multicast service/session and may start/initiate a procedure (e.g., re-acquiring MBS-related SIB or initiating an RRC resume procedure) to require valid configuration(s).

In a case that the indication indicates that the MBS multicast service/session is deactivated, the UE may stop receiving data of the MBS multicast service/session. In some instances, in a case that the indication indicates that the MBS multicast service/session is deactivated, the UE may initiate an RRC resume procedure to request for new configuration(s). After receiving the configuration(s) from dedicated signaling, the UE may start receiving data of the (interested) MBS Multicast service/session based on the updated configuration(s), for example, in either the RRC connected state or the RRC inactive state.

In some cases, the RRC resume procedure initiated by the UE may fail (e.g., a timer T300 expires.) In this case, the UE may transition back to the RRC idle state and lower layer of the UE (e.g., RRC layer) may inform upper layer of the UE (e.g., NAS layer) with release cause ‘RRC Resume failure.’ Alternatively, the UE may transition back to the RRC idle state and lower layer of the UE (e.g., RRC layer) may inform upper layer of the UE (e.g., NAS layer) with release cause to indicate MBS multicast reception failure.

In some implementations, a cell or its associated base station may broadcast an indication (e.g., with one or more bits) indicating whether an MBS multicast service/session is allowed to be received in the RRC inactive state and whether an MBS multicast service/session is activated or supported by the cell.

In some implementations, a first bit (e.g., in broadcasting system information) may indicate whether an MBS multicast service/session is allowed to be received in the RRC inactive state and a second bit (e.g., in broadcasting system information) may indicate whether an MBS multicast service/session is activated or supported by the cell.

For example, a UE may receive configuration(s) from a previous camped cell to receive data of an MBS multicast service/session. After cell (re)selection, the UE may camp on a new cell and may check both the first bit and the second bit which are received from the new cell. If the first bit is set to a specific first value (e.g., 1), the UE may determine that data of the MBS multicast service/session is allowed to be received in the RRC inactive state when camping on this cell. If the first bit is set to a specific second value (e.g., 0), the UE may determine that data of the MBS multicast service/session is not allowed to be received in the RRC inactive state when camping on this cell. If the second bit is set to a specific first value (e.g., 1), the UE may determine that the MBS multicast service/session is activated. If the second bit is set to a specific second value (e.g., 0), the UE may determine that the MBS multicast service/session is deactivated.

In a case that the first bit indicates that data of the MBS multicast service/session is allowed to be received in the RRC inactive state when camping on this cell, the second bit indicates that data of the MBS multicast service/session is activated, and the UE has valid configuration(s) to receive data of the MBS multicast service/session in RRC_INACITVE in this cell, the UE may keep receiving data of the MBS multicast service/session in the RRC inactive state.

In a case that the first bit indicates that data of the MBS multicast service/session is not allowed to be received in the RRC inactive state when camping on this cell, or the second bit indicates that the MBS multicast service/session is deactivated, or the UE has no valid configuration(s) to receive data of the MBS multicast service/session in RRC_INACITVE in this cell, the UE may stop receiving data of the MBS multicast service/session and may start procedure (e.g., re-acquiring MBS-related SIB or initiating an RRC resume procedure) to require valid configuration(s). In some instances, after receiving the configuration(s) from dedicated signaling (e.g., when initiating an RRC resume procedure), the UE may start receiving data of the (interested) MBS Multicast service/session based on the updated configuration(s), for example, in either the RRC connected state or the RRC inactive state. In some instances, after receiving the configuration(s) from broadcasting information (e.g., when re-acquiring MBS-related SIB), the UE may start receiving data of the (interested) MBS Multicast service/session based on the updated configuration(s), for example, in either the RRC connected state or the RRC inactive state.

In some cases, the RRC resume procedure initiated by the UE may fail (e.g., a timer T300 expires). In this case, the UE may transition back to the RRC idle state and lower layer of the UE (e.g., RRC layer) may inform upper layer of the UE (e.g., NAS layer) with release cause ‘RRC Resume failure.’ Alternatively, the UE may transition back to the RRC idle state and lower layer of the UE (e.g., RRC layer) may inform upper layer of the UE (e.g., NAS layer) with release cause to indicate MBS multicast reception failure.

In some implementations, a third bit (e.g., in broadcasting system information) may indicate that an MBS multicast service/session is allowed to be received in the RRC inactive state and the MBS multicast service/session is also activated (or supported by the cell). In this case, if the third bit is set to a specific first value (e.g., 1), the UE may determine that the MBS multicast service/session is allowed to be received in the RRC inactive state and the MBS multicast service/session is also activated (or supported by the cell). If the third bit is set to a specific second value (i.e., 0), the UE may determine that the MBS multicast service/session is not allowed to be received in the RRC inactive state or the MBS multicast service/session is deactivated (or not supported by the cell).

For example, a UE may receive configuration(s) from a previous camped cell to receive data of an MBS multicast service/session. After cell (re)selection, the UE may camp on a new cell and may check the third bit which is received from the new cell. In case that the third bit indicates that an MBS multicast service/session is allowed to be received in the RRC inactive state and the MBS multicast service/session is activated (or supported by the cell) and the UE has valid configuration(s) to receive data of the MBS multicast service/session in RRC_INACITVE in this cell, the UE may keep receiving data of the MBS multicast service/session in the RRC inactive state. In a case that the third bit indicates that the MBS multicast service/session is not allowed to be received in the RRC inactive state or the MBS multicast service/session is deactivated (or not supported by the cell), or the UE has NO valid configuration(s) to receive data of the MBS multicast service/session in RRC_INACITVE in this cell, the UE may stop receiving data of the MBS multicast service/session and may start procedure (e.g., re-acquiring MBS-related SIB or initiating an RRC resume procedure) to require valid configuration(s). In some instances, after receiving the configuration(s) from dedicated signaling (e.g., when initiating an RRC resume procedure), the UE may start receiving data of the (interested) MBS Multicast service/session based on the updated configuration(s), in either the RRC connected state or the RRC inactive state. In some instances, after receiving the configuration(s) from broadcasting information (e.g., when re-acquiring MBS-related SIB), the UE may start receiving data of the (interested) MBS Multicast service/session based on the updated configuration(s), for example, in either the RRC connected state or the RRC inactive state.

In some cases, the RRC resume procedure initiated by the UE may fail (e.g., a timer T300 expires). In this case, the UE may transition back to the RRC idle state and lower layer of the UE (e.g., RRC layer) may inform upper layer of the UE (e.g., NAS layer) with release cause ‘RRC Resume failure.’ Alternatively, the UE may transition back to the RRC idle state and lower layer of the UE (e.g., RRC layer) may inform upper layer of the UE (e.g., NAS layer) with release cause to indicate MBS multicast reception failure.

Validity of the Stored Configurations for Receiving Data of an MBS Multicast Service/Session in RRC_INACTIVE State In some implementations, a UE may check if stored configuration(s) for receiving data of an MBS multicast service/session in the RRC inactive state is valid before the UE starts receiving data of the MBS multicast service/session in the RRC inactive state based on the stored configurations. The stored configuration(s) for receiving data of an MBS multicast service/session in the RRC inactive state may be, for example, received via dedicated signaling (e.g., an RRC release message with suspend configuration) or via broadcasting system information.

In some implementations, configuration(s) for receiving data of an MBS multicast service/session in the RRC inactive state may be associated with a version number or a value tag. If the version number or the value tag of stored configuration(s) for receiving data of an MBS multicast service/session is different from the version number or the value tag of second configuration(s), for receiving data of the same MBS multicast service/session, which is currently received from dedicated signaling or broadcasting system information, the UE may replace the stored configuration(s) for receiving data of an MBS multicast service/session with the second configuration(s) for receiving data of the same MBS multicast service/session.

For example, a UE may receive configuration(s) for receiving data of a first MBS from a first cell and an associated version number or a value tag is ‘001’. After cell (re)selection, the UE may camp on a new second cell and may check a version number or a value tag of configuration(s) for receiving data of the first MBS broadcast by the second cell. If the associated version number or the value tag of configuration(s) for receiving data of the first MBS broadcast by the second cell is also ‘001’, the UE may keep using the stored configuration(s) (e.g., received from the first cell) to receive data of the first MBS when camping on the second cell. Otherwise, if the associated version number or the value tag of configuration(s) for receiving data of the first MBS broadcast by the second cell is not ‘001’ (e.g., ‘010’), the UE may stop using the stored configuration(s) (e.g., received from the first cell) to receive data of the first MBS when camping on the second cell. The UE may start/initiate a procedure (e.g., re-acquiring MBS-related SIB or initiating an RRC resume procedure) to require valid configuration(s).

In some implementations, if a UE initiates an RRC resume procedure due to the intention to receive data of the first MBS, the UE may set the resume cause as a specified one, e.g., MBSreception. For example, if a UE doesn't have valid configuration of the first MBS, the camped cell doesn't allow the UE to receive data of the first MBS, or the quality of data reception in the RRC inactive state is less than or equal to a configured threshold, the UE may initiate an RRC resume procedure and/or set the resume cause as a specified one, e.g., MBSreception.

### State Transition For Receiving Data of an MBS Multicast Service/Session in RRC_INACTIVE State

In some implementations, a UE may initiate an RRC resume procedure to receive data of an MBS multicast service/session in RRC_CONNCTED state for at least one of the following conditions (1) to (3).

Condition 1: the UE doesn't have valid configuration(s) for receiving data of the MBS multicast service/session in the RRC inactive state.

For example, the UE may be informed (e.g., by paging DCI, short message, or paging message) to resume the connection (e.g., for update configuration of the MBS multicast service/session.) For example, the UE may leave a configured validity area to receive data of the MBS multicast service/session in the RRC inactive state. For example, after cell re(selection), the UE may camp on a cell which does not belong to the configured validity area of an interested MBS multicast service/session. In such case, the UE may consider that the current stored configuration(s) of the interested MBS multicast service/session is not valid.

Condition (2): the camped cell doesn't allow the UE to receive data of the MBS multicast service/session in the RRC inactive state.

For example, the camped cell may broadcast an indication to indicate if receiving data of the MBS multicast service/session in the RRC inactive state is allowed or not.

Condition (3): the quality of data reception of the MBS multicast service/session in the RRC inactive state is less than (or equal to) a configured threshold.

In some implementations, the network may configure a threshold of a multicast session. For example, at least one of a reference signal received power (RSRP) threshold, a reference signal received quality (RSRQ) threshold, or a received signal strength indication (RSSI) threshold may be provided (e.g., via dedicated signaling or broadcasting system information).

For example, when a UE is in the RRC inactive state, if the UE determines that the service reception condition of an MBS multicast service/session is good (e.g., by comparing to a configured threshold of the MBS multicast service/session), the UE may keep receiving data of the MBS multicast service/session in the RRC inactive state. For example, if the measured RSRP or RSRQ is larger than (or equal to) the received RSRP or RSRQ threshold associated with an MBS multicast service/session, the UE is allowed to receive data of the MBS multicast service/session in the RRC inactive state based on the associated (valid) configuration(s).

If the UE determines that the service reception condition of an MBS multicast service/session is bad (e.g., by comparing to a configured threshold of MBS multicast service/session), the UE may stop receiving data of the MBS multicast service/session in the RRC inactive state and may initiate an RRC resume procedure. For example, if the measured RSRP or RSRQ is less than (or equal to) the received RSRP or RSRQ threshold associated with an MBS multicast service/session, the UE is not allowed to receive data of the MBS multicast service/session in the RRC inactive state.

In some implementations, different thresholds for different multicast sessions may be configured. For example, the network may configure a first threshold for a first multicast session and configure a second threshold for a second multicast session.

In some implementations, a network may update the threshold(s) of an associated MBS multicast service/session via dedicated signaling (e.g., an RRC release message with suspend configuration) or via broadcasting system information (e.g., an MBS-related SIB).

In some implementations, if a UE determines that a stored MBS-related SIB becomes invalid, the UE may re-acquire the MBS-related SIB and may update the threshold(s) accordingly.

In some implementations, if the threshold of an MBS multicast service/session is absent (e.g., absent in a received dedicated signal or absent in broadcasting system information of a current camped cell), the UE may reuse the stored threshold(s) when receiving the MBS multicast service/session in the RRC inactive state. If the UE determines that the service reception condition of the MBS multicast service/session is good (e.g., by comparing to the stored threshold of the MBS multicast service/session), the UE may keep receiving data of the MBS multicast service/session in the RRC inactive state. If the UE determines that the service reception condition of the MBS multicast service/session is bad (e.g., by comparing to the stored threshold of the MBS multicast service/session), the UE may stop receiving data of the MBS multicast service/session in the RRC inactive state and may initiate an RRC resume procedure.

In some implementations, if the threshold of an MBS multicast service/session is absent (e.g., absent in a received dedicated signal or absent in broadcasting system information of a current camped cell), a UE may determine whether to initiate an RRC resume procedure to receive the MBS multicast service/session in the RRC connected based on its implementations, network policy, or pre-configurations from the network.

In some implementations, a UE may report a status report to the network to indicate the service reception condition that the associated multicast session is not acceptable. For example, when the service reception condition(s) of one or more MBS multicast services/sessions become unacceptable, a UE may transmit a Multicast/Broadcast service status report to the network (e.g., via configured grants, dynamic grants, 2-step RA procedure, or 4-step RA procedure) to indicate the service reception condition(s) of the one or more multicast sessions are not acceptable. For example, if a UE determined that the RSRP or RSRQ of the downlink pathloss reference (e.g., a Multicast/Broadcast service reference signal) of an MBS multicast service/session is less than (or equal to) the associated RSRP or RSRQ threshold, the UE may report a Multicast/Broadcast service status report to the network to inform that the service reception condition of the MBS multicast service/session is not acceptable.

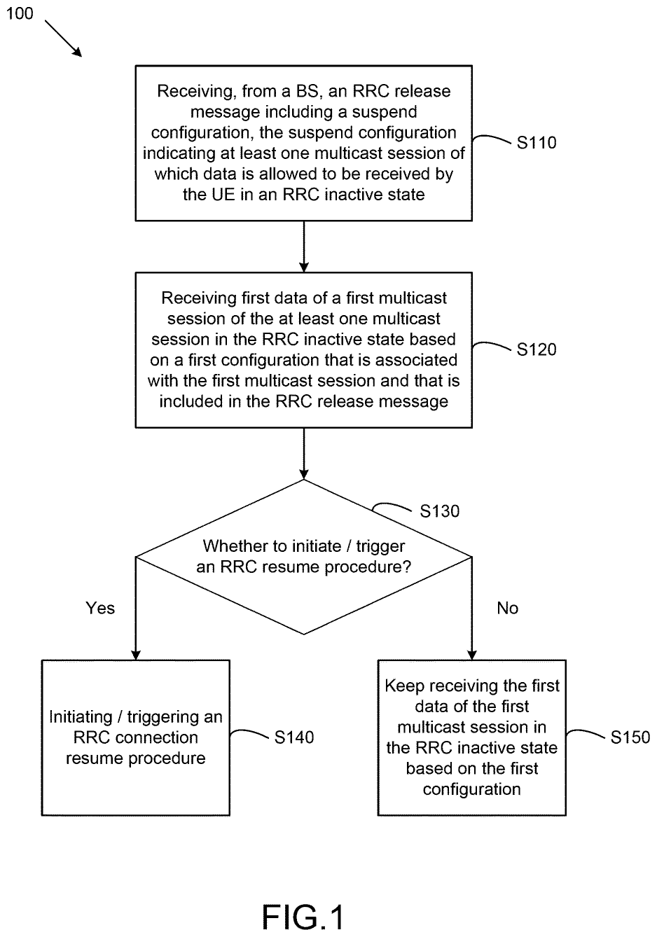

FIG. 1 is a flowchart of a method 100 for multicast data reception, according to an example implementation of the present disclosure.

It should be noted that although actions S110, S120, S130, S140, and S150 are illustrated as separate actions represented as independent blocks in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternate method. Moreover, each of actions S110, S120, S130, S140, and S150 may be performed independently of other actions and may be omitted in some implementations of the present disclosure.

In action S110, a UE may receive an RRC release message including a suspend configuration from a BS, the suspend configuration indicating at least one multicast session of which data is allowed to be received by the UE in an RRC inactive state.

Specifically, a UE in, for example, the RRC connected state or the RRC inactive state, may receive the RRC release message with suspend configuration, and the suspend configuration may indicate one or more multicast sessions of which data is allowed to be received by the UE in the RRC inactive state. In other words, the UE may be allowed to receive data of the one or more multicast sessions indicated in the suspend configuration included in the RRC release message.

In some implementations, the RRC release message may include one or more configurations corresponding to the indicated one or more multicast sessions. For example, the one or more multicast sessions may include a first multicast session and a second multicast session, and the RRC release message may include a first configuration corresponding to the first multicast session and a second configuration corresponding to the second multicast session.

In some implementations, the RRC release message may include one or more thresholds (e.g., RSRP or RSRQ thresholds) corresponding to the indicated one or more multicast sessions. For example, the one or more multicast sessions may include a first multicast session and a second multicast session, and the RRC release message may include a first threshold corresponding to the first multicast session and a second threshold corresponding to the second multicast session. As such, the UE may configure the first threshold for the first multicast session and configure the second threshold for the second multicast session. In some cases, the first threshold may be equal to the second threshold. In some cases, the first threshold may not be equal to the second threshold.

However, the present disclosure does not limit the means for measuring signal quality. For example, the RRC release message may include at least one of an RSRP threshold, an RSRQ threshold, or an RSSI threshold.

In some implementations, the UE may receive, from the base station, a configuration (e.g., a third configuration) of a neighboring cell for receiving first data of the first multicast session. The configuration may be, for example, associated with the first multicast session and received via broadcasting system information. As an example, the UE may receive, from the base station, a list of cell IDs that supports to receive data of a multicast session in RRC inactive state.

In action S120, the UE may receive first data of a first multicast session of the at least one multicast session in the RRC inactive state based on a first configuration that is associated with the first multicast session and that is included in the RRC release message. The first multicast session may be, for example, an interest multicast session for the UE.

Specifically, the first multicast session may be one of the one or more multicast sessions indicated in the suspend configuration included in the RRC release message received in action S110; therefore, data of the first multicast session is allowed to be received by the UE.

Specifically, the first configuration associated with the first multicast session may also be included in the RRC release message received in action S110.

In action S130, the UE may determine whether to initiate or trigger an RRC connection resume procedure. It should be noted that the RRC connection resume procedure may also be referred as to RRC resume procedure in the present disclosure.

Specifically, the UE may determine whether to initiate or trigger the RRC resume procedure in a case that the UE is unable to receive data of the multicast session that the UE intends to. Several situations of the case are described as implementations in the previous paragraphs.

In some implementations, the UE may determine whether to initiate or trigger the RRC resume procedure based on at least the reception quality of the received first data of the first multicast session. For example, in a case that the reception quality is lower than (or equal to) a configured threshold (e.g., the first threshold) associated with the first multicast session, the UE may determine to initiate or trigger the RRC resume procedure.

In some implementations, the UE may determine to whether to initiate or trigger the RRC resume procedure based on whether the UE has valid configuration(s) for receiving the first data of the first multicast session. For example, in a case that the UE has no valid configuration(s) for receiving first data of the first multicast session, the UE may determine to initiate or trigger the RRC resume procedure.

In some implementations, the UE may determine to whether to initiate or trigger the RRC resume procedure based on whether receiving the first data of the first multicast session in RRC inactive state is allowed. For example, in a case that receiving the first data of the first multicast session in RRC inactive state is not allowed, the UE may determine to initiate or tiger the RRC resume procedure.

In some implementations, the UE may perform a cell (re)selection procedure and join a re-selected cell. In this case, the UE may need a new configuration for the re-selected cell. In a case that the UE has received a specific configuration (e.g., a third configuration associated with the first multicast session) of a neighboring cell for receiving the first data of the first multicast session via broadcasting system information, the UE may determine to initiate or triggering the RRC resume procedure when the specific configuration is not available for the first multicast session in the re-selected cell.

In some implementations, right before or upon the UE determine to initiate or trigger the RRC resume procedure, the UE may stop receiving the first data of the first multicast session.

In a case that the UE determines to initiate or trigger the RRC resume procedure, action S140 may be performed. In action S140, the UE may initiate or trigger the RRC resume procedure (e.g., for transitioning to the RRC connected state, or to receive the configuration(s) for receiving the first data of the first multicast session in the RRC connected state or the RRC inactive state).

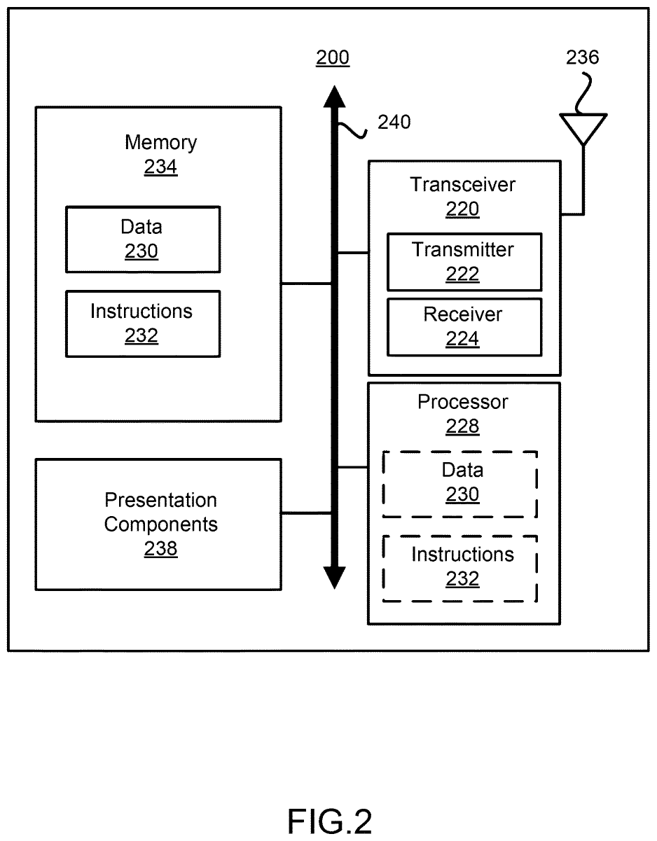

In a case that the UE determines not to initiate or trigger the RRC resume procedure, action S150 may be performed. In action S150, the UE may keep receiving the first data of the first multisession in the RRC inactive state based on the first configuration (or an updated/stored configuration.) FIG. 2 is a block diagram illustrating a node 200 for wireless communication, according to an example implementation of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a NW communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including, but not limited to, usable, non-usable and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired NW or direct-wired connection, and wireless media, such as acoustic, RF, infrared, and other wireless media. Combinations of any of the previously listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable instructions 232 (e.g., software codes or programs) that are configured to, when executed, cause the processor 228 to perform various functions disclosed herein, for example, with reference to FIGS. 1 through 7. Alternatively, the instructions 232 may not be directly executable by the processor 228 but may be configured to cause the node 200 (e.g., when compiled and executed) to perform various functions disclosed herein.

The processor 228 (e.g., having processing circuitry) may include an intelligent hardware device, e.g., a Central Processing Unit (CPU), a microcontroller, an ASIC, etc. The processor 228 may include memory. The processor 228 may process the data 230 and the instructions 232 received from the memory 234, and information transmitted and received via the transceiver 220, the baseband communications module, and/or the NW communications module. The processor 228 may also process information to send to the transceiver 220 for transmission via the antenna 236 to the NW communications module for transmission to a Core Network (CN).

One or more presentation components 238 may present data indications to a person or another device. Examples of presentation components 238 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

1. A method performed by a user equipment (UE) for receiving multicast data, the method comprising:
receiving, from a base station (BS), a radio resource control (RRC) release message comprising a suspend configuration, the suspend configuration indicating at least one multicast session, data of which is allowed to be received by the UE, while the UE is in an RRC inactive state;
receiving, while the UE is in the RRC inactive sate, first data of a first multicast session of the at least one multicast session based on a first configuration associated with the first multicast session, wherein the first configuration is included in the RRC release message;
determining whether a reception quality of the first data of the first multicast session is lower than a first threshold; and
triggering an RRC connection resume procedure in a case that the reception quality of the first data of the first multicast session is lower than the first threshold.

2-7. (canceled)

8. A user equipment (UE), comprising:
one or more non-transitory computer-readable media storing one or more computer-executable instructions; and
at least one processor coupled to the one or more non-transitory computer-readable media, the at least one processor configured to execute the one or more computer-executable instructions to cause the UE to:
receive, from a base station (BS), a radio resource control (RRC) release message comprising a suspend configuration, the suspend configuration indicating at least one multicast session, data of which allowed to be received by the UE, while the UE is in an RRC inactive state;
receive, while the UE is in the RRC inactive sate, first data of a first multicast session of the at least one multicast session based on a first configuration associated with the first multicast session, wherein the first configuration is included in the RRC release message;
determine whether a reception quality of the first data of the first multicast session is lower than a first threshold; and
trigger an RRC connection resume procedure in a case that the reception quality of the first data of the first multicast session is lower than the first threshold.

9. The UE of claim 8, wherein the first threshold is included in the RRC release message.

10. The UE of claim 8, wherein the at least one of processor is further configured to execute the one or more computer-executable instructions to cause the UE to:
stop receiving the first data of the first multicast session in a case that the reception quality of the first data of the first multicast session is lower than the first threshold.

11. The UE of claim 8, wherein the first threshold comprises at least one of a reference signal received power (RSRP) threshold or a reference signal received quality (RSRQ) threshold.

12. The UE of claim 8, wherein the at least one processor is further configured to execute the one or more computer-executable instructions to cause the UE to:
configure the first threshold for the first multicast session; and
configure a second threshold for a second multicast session of the at least one multicast session.

13. The UE of claim 8, wherein the at least one processor is further configured to execute the one or more computer-executable instructions to cause the UE to:
trigger the RRC connection resume procedure further in a case that the UE has no valid configurations for receiving the first data of the first multicast session.

14. The UE of claim 8, wherein the at least one processor is further configured to execute the one or more computer-executable instructions to cause the UE to:
receive, via broadcast system information, a second configuration of a neighboring cell for receiving the first data of the first multicast session, wherein the second configuration is associated with the first multicast session;
perform a cell reselection procedure to join a re-selected cell; and
trigger the RRC connection resume procedure further in a case that the second configuration associated with the first multicast session is not available for the first multicast session in the re-selected cell.

15. A base station (BS), comprising:
one or more non-transitory computer-readable media storing one or more computer-executable instructions; and
at least one processor coupled to the one or more non-transitory computer-readable media, the at least one processor configured to execute the one or more computer-executable instructions to cause the BS to:
transmit, to a user equipment (UE), a radio resource control (RRC) release message comprising a suspend configuration, the suspend configuration indicating at least one multicast session, data of which is allowed to be received by the UE, while the UE is in an RRC inactive state, wherein the RRC release message further comprises at least one configuration associated with the at least one multicast session and causes the UE to:
receive, while the UE is in the RRC inactive sate, first data of a first multicast session of the at least one multicast session based on a first configuration associated with the first multicast session, wherein the first configuration is included in the RRC release message;
determine whether a reception quality of the first data of the first multicast session is lower than a first threshold; and
trigger an RRC connection resume procedure in a case that the reception quality of the first data of the first multicast session is lower than the first threshold.

16. The BS of claim 15, wherein the first threshold is included in the RRC release message.

17. The BS of claim 15, wherein the RRC release message further causes the UE to:
stop receiving the first data of the first multicast session in a case that the reception quality of the first data of the first multicast session is lower than the first threshold.

18. The BS of claim 15, wherein the first threshold comprises one of a reference signal received power (RSRP) threshold or a reference signal received quality (RSRQ) threshold.

19. The BS of claim 15, wherein the RRC release message further causes the UE to:
configure the first threshold for the first multicast session; and
configure a second threshold for a second multicast session of the at least one multicast session.

20. The BS of claim 15, wherein the RRC release message further causes the UE to:
trigger the RRC connection resume procedure further in a case that the UE has no valid configurations for receiving the first data of the first multicast session.

21. The BS of claim 15, wherein the at least one processor is further configured to execute the one or more computer-executable instructions to cause the BS to:
broadcast, via system information, a second configuration of a neighboring cell for receiving the first data of the first multicast session, wherein the second configuration is associated with the first multicast session and causes the UE to:
perform a cell reselection procedure to join a re-selected cell; and
trigger the RRC connection resume procedure further in a case that the second configuration associated with the first multicast session is not available for the first multicast session in the re-selected cell.
